(19) United States
(12) Patent Application Publication
(10) Pub. No.: US 2009/0137701 A1
(43) Pub. Date: May 28, 2009

(54) Pneumatic Tire

(75) Inventor: Kazuya Hirabayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/274,484

(22) Filed: Nov. 20, 2008

(30) Foreign Application Priority Data
Nov. 27, 2007 (JP) 2007-305456

(51) Int. Cl. C08J 5/14

(52) U.S. Cl. 523/157

(57) ABSTRACT

A pneumatic tire having excellent balance between low fuel consumption and grip property and capability of suppressing crack generation in a tread groove bottom while maintaining abrasion resistance is provided. The pneumatic tire has a tread formed from a rubber composition includes per 100 parts by weight of a diene rubber containing a styrene-butadiene rubber, from 30 to 150 parts by weight of a reinforcing filler containing from 20 to 100 parts by weight of silica, and from 5 to 40 parts by weight of a carboxyl-terminally modified liquid polybutadiene, and further includes a silane coupling agent in an amount of from to 25 parts by weight per 100 parts by weight of the silica.

### CROSS-REFERENCE TO RELATED APPLICATIONS

This application is based upon and claims the benefit of priority from the prior Japanese Patent Application No. 2007-305456, filed on Nov. 27, 2007; the entire contents of which are incorporated herein by reference.

### BACKGROUND ART

The present invention relates to a pneumatic tire.

In recent years, globalization proceeds, and a pneumatic tire is delivered to various regions of from low temperature region to high temperature region. For this reason, cases are increased that a pneumatic tire is used in conditions severer than use conditions predicted up to now, and this is the factor of crack generation at a bottom of groove provided on a tread part.

Examples of the method for suppressing such a generation of creaks in the tread groove bottom include an increase in the amount of an age resister, an increase in the amount of a wax, adoption of groove shape reducing local strain in the grove bottom during running, compounding a non-diene rubber having durability with a tread rubber (see JP-A-11-254904), and compounding staple fibers or flake minerals with a tread rubber (JP-A-2006-290986 and JP-A-2006-131744).

However, in the method of increasing the amount of an age resister or a wax, low fuel consumption deteriorates, and rigidity of a tire is decreased, resulting in deterioration in drivability. Furthermore, in the countermeasure by a groove shape, the degree of freedom of design of a tread pattern is restricted. Therefore, improvement by compounding a rubber is desirable. In the case that a non-diene rubber is used, the non-diene rubber generally has the problem on fracture properties. This problem becomes the causes of abrasion resistance and cut chip properties, and further, raises deterioration in low fuel consumption and grip property. Furthermore, the case of compounding staple fibers or flake minerals generally brings about a decrease in abrasion resistance.

JP-A-07-188468 proposes a composition comprising 100 parts by weight of a rubber component containing a copolymer comprising a conjugated diene and a vinyl aromatic hydrocarbon, the copolymer having a tertiary amine at four polymer terminals, and containing a silicon-carbon bond, from 50 to 150 parts by weight of carbon black having N₂SA of 110 m²/g or more, and 30 parts by weight or more of an aroma oil and a liquid polymer, as rubber composition having excellent rupture properties and abrasion resistance and high grip property. However, this reference does not disclose a carboxyl-terminally modified liquid polybutadiene, and further is silent on an effect of suppressing crack generation in a tread groove bottom.

JP-A-2003-12860 discloses a composition comprising per 100 parts by weight of a rubber component comprising a natural rubber and a specific butadiene rubber, from 45 to 60 parts by weight of carbon black, from 2 to 10 parts by weight of silica, and from 2 to 10 parts by weight of a modified liquid butadiene rubber having hydroxyl group and/or carboxyl group, as a rubber composition having improved cut chip properties without impairing abrasion resistance and processability. However, this reference is mainly directed to a large-sized tire. Therefore, a rubber component comprises a blend of a natural rubber and a butadiene rubber. Furthermore, in this reference, silica is compounded in a small amount of 10 parts by weight or less to improve cut chip properties, and co-use of a silane coupling agent is excluded. Additionally, this reference does not suggest at all that by using a carboxyl-modified liquid polybutadiene in place of an oil generally used, change in hardness of a tire tread rubber with the passage of time is suppressed, and crack generation in a tread groove bottom can be suppressed.

### SUMMARY OF THE INVENTION

The present invention has been made in view of the above. Accordingly, an object of the present invention is to provide a pneumatic tire having excellent balance between low fuel consumption and grip property and capability of suppressing crack generation in a tread groove bottom while maintaining abrasion resistance.

The pneumatic tire according to the present invention has a tread formed from a rubber composition which comprises per 100 parts by weight of a diene rubber containing a styrene-butadiene rubber, from 30 to 150 parts by weight of a reinforcing filler containing from 20 to 100 parts by weight of silica, and from 5 to 40 parts by weight of a carboxyl-terminally modified liquid polybutadiene, and further comprises a silane coupling agent in an amount of from 2 to 25 parts by weight per 100 parts by weight of the silica.

According to the present invention, by substituting a carboxyl-terminally modified liquid polybutadiene for at least a part of an oil generally used as a softener, migration into other member is suppressed, and hardening of a tread rubber can be prevented. Specifically, change in hardness of a tire tread rubber with the passage of time can be suppressed, and crack generation in a tread groove bottom can be suppressed. Furthermore, abrasion resistance of a tire can be maintained even though a super abrasion-resistant carbon black such as SAF class is not used, and the balance between low fuel consumption and grip property is also excellent.

### DETAILED DESCRIPTION OF THE INVENTION

The embodiment of the present invention is described in detail below.

The diene rubber used in the rubber composition according to the present invention is a styrene-butadiene rubber (SBR) alone or a blend rubber of SBR and other diene rubber. Examples of the other diene rubber include various diene rubbers generally used in a rubber composition for tire tread, such as a natural rubber (NR), an isoprene rubber (IR), a butadiene rubber (BR), a styrene-isoprene copolymer rubber, a butadiene-isoprene copolymer rubber and a styrene-isoprene-butadiene copolymer rubber. Those other diene rubbers can be used alone or as blends of two or more thereof. In the case that SBR and the other diene rubber are blended, a blend of 50% by weight or more of SBR and 50% by weight or less of the other diene rubber is preferred.

The reinforcing filler used in the rubber composition according to the present invention is at least silica. Specifically, the reinforcing filler used is silica alone or a combination of silica and other reinforcing filler. Preferably, a blend of silica and carbon black is used.

The silica is not particularly limited, but wet silica comprising hydrous silicic acid as a main component is preferably used. BET specific surface area (BET method measured according to ISO 5794/1) of the silica is not particularly limited, but the BET specific surface area is preferably from 100 to 300 m²/g.

The carbon black used together with the silica is preferably is HAF and ISAF classes having a nitrogen adsorption specific surface area (N₂SA) of from 60 to 120 m²/g. Carbon black of SAF class having a nitrogen adsorption specific surface area exceeding 120 m²/g has excellent abrasion resistance, but is disadvantageous to rolling resistance (low fuel consumption). By using carbon black having a nitrogen adsorption specific surface area fallen within the above range, the balance between low fuel consumption and grip property can further be improved. The nitrogen adsorption specific surface area used herein is measured according to JIS K6217-1 (2001).

The compounding amount of the reinforcing filler can be a general compounding amount in a rubber composition for tire tread. In detail, the reinforcing filler is compounded in an amount of from 30 to 150 parts by weight per 100 parts by weight of the diene rubber. More preferably, the reinforcing filler is compounded in an amount of from 50 to 100 parts by weight per 100 parts by weight of the diene rubber.

In the compounding amount of the reinforcing filler, the silica is compounded in an amount of from 20 to 100 parts by weight per 100 parts by weight of the diene rubber. By compounding a given amount of the silica, the balance between low fuel consumption and grip property can be improved. The compounding amount of the silica is more preferably from 30 to 60 parts by weight per 100 parts by weight of the diene rubber.

To promote bonding between the silica and the diene rubber, a silane coupling agent is co-used. The silane coupling agent is compounded in an amount of from 2 to 25 parts by weight, and more preferably from 5 to 15 parts by weight, per 100 parts by weight of the silica.

The silane coupling agent can use any compound so long as it is conventionally used in a rubber composition together with silica. Examples of the silane coupling agent used include bis(3-triethoxysilylpropyl)tetrasulfide, bis(3-triethoxysilylpropyl)disulfide, bis(2-triethoxysilylethyl)tetrasulfide, 3-mercaptopropyltrimethoxysilane, 3-mercaptopropyltriethoxysilane, 3-nitropropyltrimethoxysilane and γ-aminopropyltriethoxysilane.

The carboxyl-terminally modified liquid polybutadiene is compounded with the rubber composition according to the present invention. The liquid polybutadiene is a polybutadiene which is liquid at ordinary temperatures (that is, 25° C.). The present invention uses a modified liquid polybutadiene having a carboxyl group in at least one terminal thereof.

The carboxyl-terminally modified liquid polybutadiene is obtained by modifying the terminal of a liquid polybutadiene with a compound having a carboxyl group. The compound having a carboxyl group is not particularly limited. Examples of the compound include unsaturated carboxylic acids such as acrylic acid, methacrylic acid, crotonic acid, cinnamic acid, itaconic acid, fumaric acid, maleic acid or butenetricarboxylic acid, and monoalkyl esters of unsaturated dicarboxylic acids such as itaconic monoethyl ester, fumaric monobutyl ester or maleic monobutyl ester.

By compounding the carboxyl-terminally modified liquid polybutadiene so as to substitute the same for at least a part of an oil generally compounded as a softener, migration into other member is suppressed, and change in hardness of a tread rubber with the passage of time can be suppressed. Specifically, an oil compounded with a tread rubber bleeds with the use of a tire and migrates into other member, and this induces hardening of a tread rubber, resulting in the factor that cracks are generated in a tread groove bottom. However, the use of the carboxyl-terminally modified liquid polybutadiene can overcome those disadvantages. When the liquid polymer is a polybutadiene, the above effect can be increased. Furthermore, by that a terminal is carboxyl-modified, migration into other member can be suppressed by an interaction with the reinforcing filler, particularly silica.

The carboxyl-terminally modified liquid polybutadiene preferably has a number average molecular weight of from 500 to 20,000. By using the liquid polybutadiene having such a number average molecular weight, processability when used in place of an oil can be maintained. The number average molecular weight is measured by ASTM D2503.

The amount of the carboxyl-terminally modified liquid polybutadiene compounded is from 5 to 40 parts by weight, and more preferably from 15 to 30 parts by weight, per 100 parts by weight of the diene rubber. Where the compounding amount of the liquid polybutadiene is too small, an effect of suppressing crack generation in a tread groove bottom is not obtained. On the other hand, where the compounding amount is too large, low fuel consumption deteriorates.

From the point that the carboxyl-terminally modified liquid polybutadiene is used by substituting for an oil, the total amount of the carboxyl-terminally modified liquid polybutadiene and the oil is preferably from 25 to 50 parts by weight, and more preferably from 30 to 40 parts by weight, per 100 parts by weight of the diene rubber.

Other than the above components, various additives generally used in a rubber composition for tire tread, such as stearic acid, zinc white, age resisters, waxes, sulfur or vulcanization accelerators, can be compounded with the rubber composition according to the present invention.

The rubber composition as described above is used as a rubber composition forming a tread rubber of a pneumatic tire having main grooves extending in a tire circumferential direction and transverse grooves extending in a direction crossing the main grooves, on a tread. Therefore, in a pneumatic tire having a tread rubber of a two-layer structure comprising a cap rubber layer and a base rubber layer, the rubber composition is used as at least a rubber forming a cap rubber layer which forms a grounding surface.

Such a pneumatic tire can be produced according to the conventional methods. Specifically, the rubber composition is mixed with a mixing machine such as a roll or a mixer, and molded into a sheet. The sheet is laminated on a belt, and vulcanized and molded according to the conventional methods to form a tread rubber. Thus, a pneumatic tire is obtained.

### EXAMPLES

The present invention is described by the following Examples, but the invention is not construed as being limited thereto.

Each rubber composition for tread of Examples and Comparative Examples was prepared using Banbury mixer according to the formulation shown in Table 1 below. Each component in Table 1 is as follows.

SBR: Styrene-butadiene rubber SBR1502, manufactured by JSR Corporation

BR: Butadiene rubber BR150B, manufactured by Ube Industries, Ltd.

NR: Natural rubber RSS#3

CB1: Carbon black SAF (DIA BLACK A, nitrogen adsorption specific surface area: 142 m²/g, manufactured by Mitsubishi Chemical Corporation)

CB2: Carbon black ISAF (DIA BLACK I, nitrogen adsorption specific surface area: 114 m²/g, manufactured by Mitsubishi Chemical Corporation)

CB3: Carbon black HAF-LS (DIA BLACK LH, nitrogen adsorption specific surface area: 84 m²/g, manufactured by Mitsubishi Chemical Corporation)

Silica: NIPSIL AQ (BET specific surface area: 205 m²/g), manufactured by Nippon Silica

Silane coupling agent: Si69, manufactured by Degussa

Oil: JOMO PROCESS NC-140, manufactured by Japan Energy Corporation

Carboxyl-terminally modified liquid BR1: Liquid polybutadiene CTBN 1300×31 (carboxyl-terminally modified, number average molecular weight: 3,500), manufactured by Ube Industries, Ltd.

Carboxyl-terminally modified liquid BR2: Liquid polybutadiene CTBN 2000×162 (carboxyl-terminally modified, number average molecular weight: 4,800), manufactured by Ube Industries, Ltd.

Unmodified liquid BR: Liquid polybutadiene NISSO-PB B-3000 (terminally unmodified, number average molecular weight: 3,000), manufactured by Nippon Soda Co., Ltd.

Hydroxyl-terminally modified liquid BR: Liquid polybutadiene R-45HT (hydroxyl-terminally modified, number average molecular weight: 2,800), manufactured by Idemitsu Kosan Co., Ltd.

As the common formulation, 2 parts by weight of stearic acid (RUNAX S-20, manufactured by Kao Corporation), 3 parts by weight of zinc white (Zinc White #1, manufactured by Mitsui Mining & Smelting Co., Ltd.), 2 parts by weight of an age resister (SANTOFLEX 6PPD, manufactured by FLEXSYS), 2 parts by weight of a wax (OZOACE 0355, manufactured by Nippon Seiro Co., Ltd.), 1.8 parts by weight of a vulcanization accelerator (NOCCELLAR D, manufactured by Ouchi Shinko Chemical Industrial Co., Ltd.), 2 parts by weight of a vulcanization accelerator (NOCCELLAR CZ-G, manufactured by Ouchi Shinko Chemical Industrial Co., Ltd.) and 1.5 parts by weight of sulfur (powdery sulfur 150 mesh, manufactured by Hosoi Chemical Industry Co., Ltd.) were compounded per 100 parts by weight of a diene rubber in each rubber composition.

Each rubber composition obtained was used as a tread rubber, and a pneumatic radial tire of 185/70R14 was produced according to the conventional method. Rolling resistance, grip property and abrasion resistance of the tire were evaluated, and an effect of suppressing cracks in a tread groove bottom was evaluated. Each evaluation test is as follows.

Rolling resistance: A rim of 14×6.5-JJ was used, and a tire was mounted thereto. Rolling resistance was measured when running on a single-axis drum tester for rolling resistance measurement at 80 km/hr at 23° C. with air pressure of 230 kPa under load 450 kgf. The result was indicated by an index as the value of Comparative Example 1 being 100. Smaller index shows that rolling resistance is small, and therefore fuel efficiency is excellent.

Grip property: Four tires obtained above were used in a 2000 cc passenger car, and the car was run on an asphalt pavement in dry grip and an asphalt pavement on which water was sprayed in a depth of 2 to 3 mm in wet grip. Friction coefficient was measured at 100 km per hour, and grip property was evaluated. The result was indicated by an index as the value of Comparative Example 1 being 100. The grip performance is good as the value is large.

Abrasion resistance: Four tires obtained above were used in a 2000 cc passenger car. While conducting tire rotation every running distance of 2,500 km, residual groove depth (average value of four tires) of a tread after running 10,000 km was obtained. The result was indicated by an index as the value of Comparative Example 1 being 100. The abrasion resistance is excellent as the index is large.

Crack in tread groove bottom: A tire was hot aged at 80° C. for 4 weeks, and run on a drum in a distance of 10,000 km. The presence or absence of crack generation in a tread groove bottom of the tire after running was visually confirmed.

TABLE 1

| | | Com. | Com. | Com. | Com. | Com. | | | | | | | | | Com. | Com. | Com. | Com. |
|---|---|---|---|---|---|---|---|---|---|---|---|---|---|---|---|---|---|---|
| | | Ex. 1 | Ex. 2 | Ex. 3 | Ex. 4 | Ex. 5 | Ex. 1 | Ex. 2 | Ex. 3 | Ex. 4 | Ex. 5 | Ex. 6 | Ex. 7 | Ex. 8 | Ex. 6 | Ex. 7 | Ex. 8 | Ex. 9 |
| Formulation | SBR | 60 | 60 | 60 | 60 | 60 | 60 | 60 | 60 | 60 | 60 | 60 | 60 | 60 | 60 | 60 | 60 | 60 |
| (parts by | BR | 25 | 25 | 25 | 25 | 25 | 25 | 25 | 25 | 25 | 25 | 25 | 25 | 25 | 25 | 25 | 25 | 25 |
| weight) | NR | 15 | 15 | 15 | 15 | 15 | 15 | 15 | 15 | 15 | 15 | 15 | 15 | 15 | 15 | 15 | 15 | 15 |
| | CB1 | 70 | | | 35 | | | | | | 35 | | | | | | | |
| | CB2 | | 70 | 70 | | 35 | 35 | 35 | 35 | | | 35 | 50 | 10 | 35 | 35 | 35 | 35 |
| | CB3 | | | | | | | | | 35 | | | | | | | | |
| | Silica | | | | 35 | 35 | 35 | 35 | 35 | 35 | 35 | 35 | 20 | 60 | 35 | 35 | 35 | 35 |
| | Silane | | | | 3.5 | 3.5 | 3.5 | 3.5 | 3.5 | 3.5 | 3.5 | 3.5 | 2.0 | 6.0 | 3.5 | 3.5 | 3.5 | 3.5 |
| | coupling | | | | | | | | | | | | | | | | | |
| | agent | | | | | | | | | | | | | | | | | |
| | Oil | 35 | 35 | 15 | 35 | 35 | 15 | 25 | 5 | 15 | 15 | 15 | 15 | 15 | 32 | | 15 | 15 |
| | Carboxyl- | | | 20 | | | 20 | 10 | 30 | 20 | 20 | | 20 | 20 | 3 | 50 | | |
| | terminally | | | | | | | | | | | | | | | | | |
| | modified | | | | | | | | | | | | | | | | | |
| | liquid BR1 | | | | | | | | | | | | | | | | | |
| | Carboxyl- | | | | | | | | | | | 20 | | | | | | |
| | terminally | | | | | | | | | | | | | | | | | |
| | modified | | | | | | | | | | | | | | | | | |
| | liquid BR2 | | | | | | | | | | | | | | | | | |
| | Unmodified | | | | | | | | | | | | | | | | 20 | |
| | liquid BR | | | | | | | | | | | | | | | | | |
| | Hydroxyl- | | | | | | | | | | | | | | | | | 20 |
| | terminally | | | | | | | | | | | | | | | | | |
| | modified | | | | | | | | | | | | | | | | | |
| | liquid BR | | | | | | | | | | | | | | | | | |
| Rolling resistance | | 100 | 92 | 99 | 97 | 89 | 97 | 94 | 100 | 94 | 104 | 98 | 95 | 99 | 90 | 110 | 100 | 98 |
| Grip | Wet | 100 | 98 | 104 | 104 | 103 | 109 | 105 | 111 | 106 | 112 | 106 | 105 | 111 | 104 | 113 | 106 | 107 |
| property | Dry | 100 | 95 | 100 | 103 | 99 | 106 | 102 | 108 | 103 | 108 | 103 | 103 | 108 | 101 | 110 | 103 | 105 |

| | | | | | | | | | | | | | | | | | |
|---|---|---|---|---|---|---|---|---|---|---|---|---|---|---|---|---|---|
| Abrasion resistance | 100 | 90 | 99 | 103 | 93 | 102 | 99 | 104 | 99 | 108 | 100 | 99 | 104 | 95 | 105 | 97 | 99 |
| Crack in tread | A | A | B | A | A | B | B | B | B | B | B | B | B | A | B | A | B |
| groove bottom | | | | | | | | | | | | | | | | | |

A: Generation
B: No generation

As shown in Table 1, use of the rubber composition according to the Examples suppressed crack generation in a tread groove bottom. Furthermore, even though super abrasion-resistant carbon black of SAF class was not used, abrasion resistance of a tire could be maintained, and the balance between low fuel consumption and grip property could be improved. Regarding the kind of a terminally-modified group of the liquid polybutadiene, as is apparent from the comparison between Example 1 and Comparative Example 9, it was recognized that Example 1 which is carboxyl-terminally modified shows advantageous effect in wet grip property and particularly abrasion resistance as compared with Comparative Example 9 which is hydroxyl-terminally modified.

The present invention can preferably be used in various pneumatic tires including pneumatic radial tires for passenger cars.

What is claimed is:

1. A pneumatic tire having a tread formed from a rubber composition comprising, per 100 parts by weight of a diene rubber containing a styrene-butadiene rubber, from 30 to 150 parts by weight of a reinforcing filler containing from 20 to 100 parts by weight of silica, and from 5 to 40 parts by weight of a carboxyl-terminally modified liquid polybutadiene, and further comprising a silane coupling agent in an amount of from 2 to 25 parts by weight per 100 parts by weight of the silica.

2. The pneumatic tire as claimed in claim 1, wherein the reinforcing filler further comprises carbon black having a nitrogen adsorption specific surface area of from 60 to 120 m²/g.

3. The pneumatic tire as claimed in claim 1, wherein the silica has a BET specific surface area of from 100 to 300 m²/g.

4. The pneumatic tire as claimed in claim 2, wherein the silica has a BET specific surface area of from 100 to 300 m²/g.
